(19) United States
(12) Patent Application Publication
(10) Pub. No.: US 2014/0106917 A1
(43) Pub. Date: Apr. 17, 2014

(54) Synchronous Belt Sprocket and System

(71) Applicant: THE GATES CORPORATION, DENVER, CA (US)

(72) Inventors: Jing YUAN, Rochester Hills, MI (US); Robert david Parnell, Dimfries (GB); Arthur Clarke, Dumfries (GB)

(73) Assignee: THE GATES CORPORATION, DENVER, CA (US)

(21) Appl. No.: 13/653,832

(22) Filed: Oct. 17, 2012

(51) Int. Cl. F16H 55/17

(52) U.S. Cl. 474/148

(57) ABSTRACT

A sprocket system comprising a first sprocket (100) comprising a plurality of transverse first teeth (101) extending parallel to an axis of rotation (A-A) and having a first pitch (P1), the first sprocket further comprising a plurality of transverse second teeth (102) having a second pitch (P2) and disposed immediately adjacent the first teeth, the second teeth parallel to the first teeth, a tooth of said first teeth aligned with a radius (A) of said first sprocket, a tooth of said second teeth offset a distance (x) from said radius (A), wherein (x) is greater than zero, a second sprocket (200), and a toothed belt (300) entrained between the first sprocket and the second sprocket.

### TECHNICAL FIELD

The invention relates to a synchronous belt sprocket and system and more particularly to a synchronous belt sprocket system having a sprocket comprising a plurality of first transverse teeth and adjacent second transverse teeth.

### BACKGROUND

Sprocket and belt combinations are well known and there are many different types of belts and many different combinations of belts and sprockets. The belt application typically determines the belt construction, while the belt construction is a factor in the sprocket construction. If the inner face of the belt is comprised of teeth, then the outer face of the drive sprocket, which contacts the inner face of the belt, is conventionally formed with grooves corresponding to the tooth profile of the belt. For synchronous drive belts wherein the teeth extend laterally across the width of the belt, the corresponding sprockets are provided with flanges to prevent the belt from tracking off of the sprocket. For drive belts with self-tracking tooth profiles, the sprockets do not require flanges to restrain the axial movement of the belt.

In operation a toothed belt system will generate noise. This is primarily due to engagement or meshing between the teeth of the belt and the groves of the sprocket. Motor noise is discounted as a given. The belt noise can be objectionable depending on the intensity and the associated service in which the system is being used.

Representative of the art is US application no. 20020119854 which discloses a drive system comprising a driver pulley, a driven pulley, and a belt. The belt has a pulley engaging surface comprised of a plurality of transversely extending self-tracking teeth. The driven pulley has a non-grooved, crownless belt engaging surface. The material forming the pulley engaging surface of the belt having a relatively low coefficient of friction, and the material forming the belt engaging surface of the driven pulley having a relatively high coefficient of friction.

What is needed is a sprocket system using a sprocket having a plurality of first transverse teeth and adjacent second transverse teeth thereby reducing operating system noise. The present invention meets this need.

### SUMMARY OF THE EMBODIMENTS

The primary aspect of the invention is to provide a sprocket system using a sprocket having a plurality of first transverse teeth and adjacent second transverse teeth thereby reducing operating system noise.

Other aspects of the invention will be pointed out or made obvious by the following description of the invention and the accompanying drawings.

The invention comprises a sprocket system comprising a first sprocket comprising a plurality of transverse first teeth extending parallel to an axis of rotation (A-A) and having a first pitch (P1), the first sprocket further comprising a plurality of transverse second teeth having a second pitch (P2) and disposed immediately adjacent the first teeth, the second teeth parallel to the first teeth, a tooth of said first teeth aligned with a radius (R) of said first sprocket, a tooth of said second teeth offset a distance (x) from said radius (R), wherein (x) is greater than zero, a second sprocket, and a toothed belt entrained between the first sprocket and the second sprocket.

### BRIEF DESCRIPTION OF THE DRAWINGS

FIG. 1 is a perspective view of the inventive system.

FIG. 2 is a side view of a sprocket.

FIG. 3 is a top view of a sprocket.

FIG. 4 is a perspective view of a sprocket.

FIG. 5 is a graph of an overall dB comparison between different belt systems.

FIG. 6 is a chart of the parameters for the tested systems.

FIG. 7 is a perspective view of an inventive sprocket.

### DETAILED DESCRIPTION

Unless otherwise indicated, all numbers expressing dimensions and so forth used in the specification and claims are to be understood as being modified in all instances by the term “about”.

In this application and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

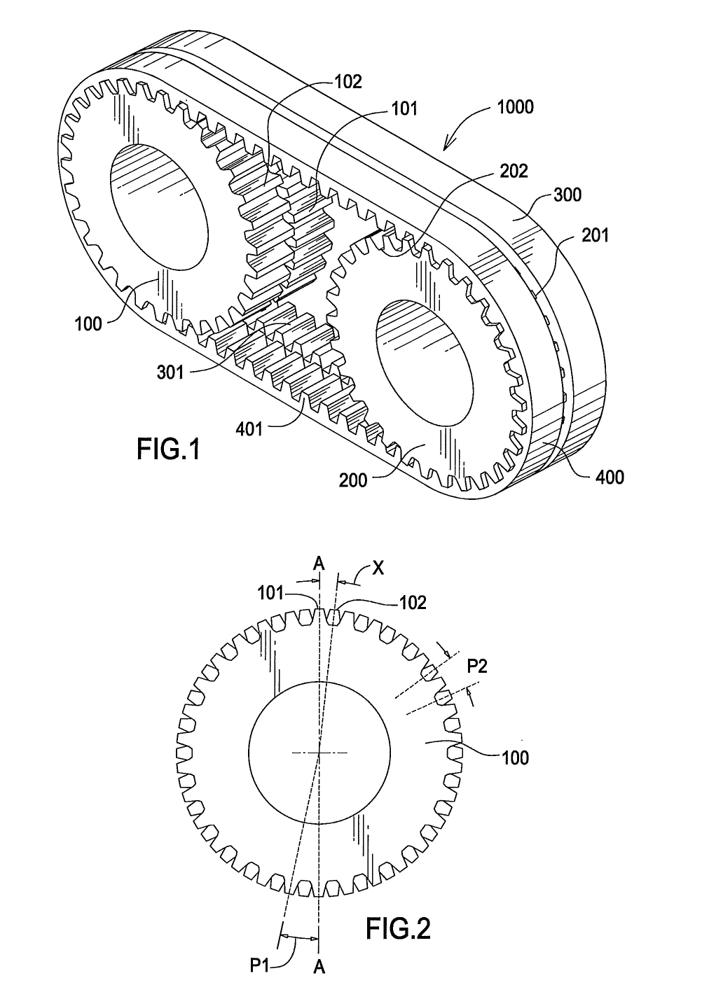

FIG. 1 is a perspective view of the inventive system. The system comprises a first sprocket 100 and a second sprocket 200. In a typical system first sprocket 100 would act as a driver sprocket and second sprocket 200 would act as a driven sprocket.

A first belt 300 is entrained about sprockets 100, 200. A second belt 400 is trained about sprockets 100, 200. First belt 300 and second belt 400 comprise toothed belts, each having teeth disposed on a longitudinal surface. First belt 300 comprises teeth 301. Second belt 400 comprises teeth 401.

Teeth 301 engage a toothed surface 101 on sprocket 100. Teeth 401 engage a toothed surface 102 on sprocket 100. Teeth 301 also engage a toothed surface 201 on sprocket 200. Teeth 401 also engage a toothed surface 202 on sprocket 200.

Sprocket 100 comprises a first toothed surface 101 comprising transverse teeth extending parallel to an axis of rotation A-A. Sprocket 100 further comprises a second toothed surface 102 disposed immediately adjacent the first toothed surface 101, Second teeth on toothed surface 102 are parallel to the first teeth on toothed surface 101.

Teeth 301 and teeth 401 may comprise any suitable shape or profile known in the art. Teeth on the toothed surfaces 101, 102, 201, 202 may comprise any cooperating profile suitable for engaging belt 300 and belt 400.

Sprocket 100 and sprocket 200 may be of equal or unequal diameters. Further, the diameter for toothed surface 101 may be equal or unequal to the diameter of adjacent toothed surface 102. Further, the diameter for toothed surface 201 may be equal or unequal to the diameter of adjacent toothed surface 202.

In operation it is preferable that each belt 300, 400 be made to track toward the outer portion of sprocket 100 and sprocket 200. The will reduce the possibility of the belts coming in contact or rubbing together. Methods relating to belt tracking control are known in the art.

FIG. 2 is a side view of a sprocket. Teeth on toothed surface 101 and 201 are spaced apart from each other by what is referred to as the “pitch”, which is a distance (P1) between adjacent teeth. Teeth on toothed surfaces 102 and 202 are also spaced with a pitch (P2). Assuming a given toothed surface 101 is aligned with reference line “A” which aligns with a radius (R), the teeth on surface 102 are offset from the adjacent toothed surface 101 by a distance (x) which is a fraction of the pitch (P1) between 0 and 1. The offset may be adjusted during design in order to minimize or cancel noise generated by the belt engaging the sprocket. Pitches are typically 8 mm, 10 mm, 14 mm or some other value depending upon the requirements of the system.

In the preferred embodiment (x) is ½ the pitch (P1) for the given sprocket or belt. Hence, for the situation where the pitches of the adjacent toothed surfaces 101, 102 are equal, the teeth on surface 102 are disposed in alignment with the grooves 103 between teeth on surface 101. Distance (x) may be any value between zero and P1 or P2.

Pitch P1 and pitch P2 may or may not be equal depending upon system requirements.

In the preferred embodiment the pitch is equal for belt 300 and belt 400. In an alternate embodiment, belt 300 and belt 400 may have different pitches, for example, belt 300 has a pitch of 8 mm and belt 400 has a pitch of 10 mm.

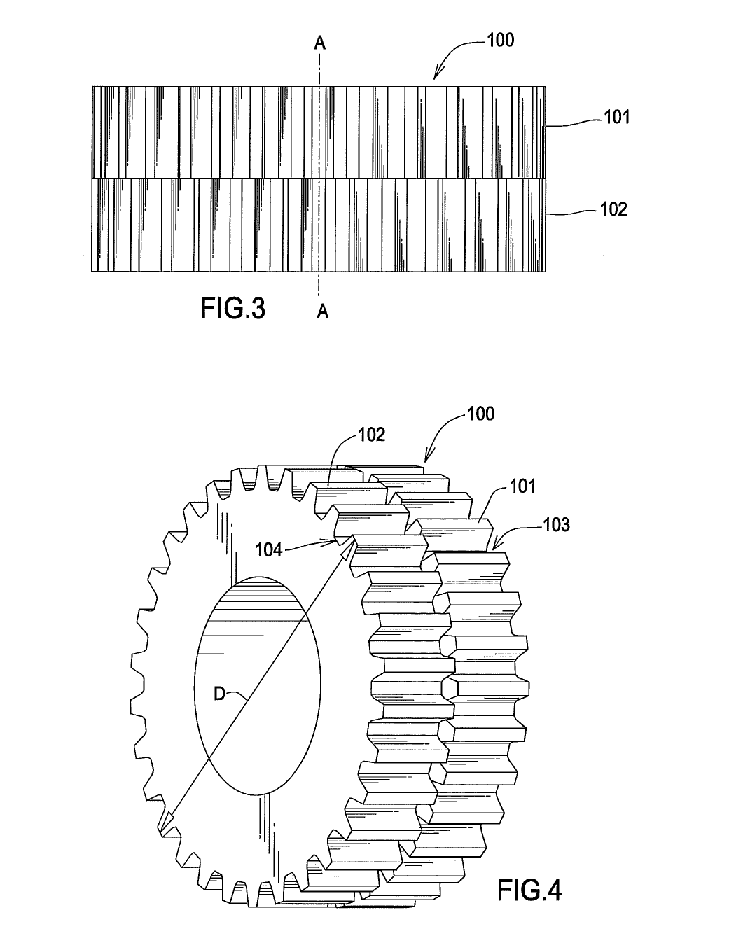

FIG. 3 is a top view of a sprocket. Teeth on surface 101 are disposed adjacent teeth on surface 102. Sprocket 100 comprises adjacent rows of teeth on surface 101 and surface 102 on an outer belt engaging surface. Each sprocket rotates about an axis of rotation A-A.

FIG. 4 is a perspective view of a sprocket. Each toothed surface may comprise an equal or unequal diameter D.

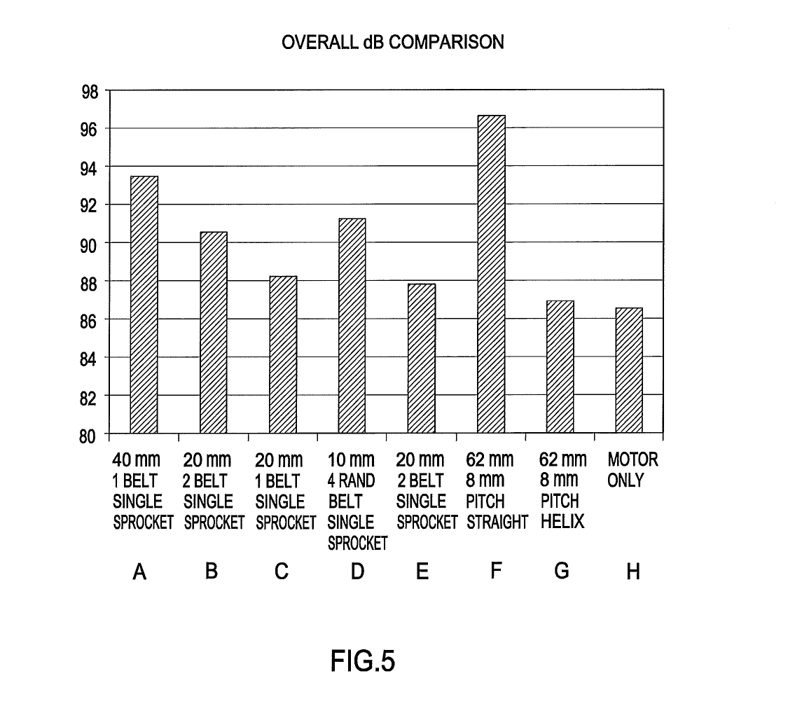

An advantage of the inventive system is the significant reduction in drive noise. The system typically produces a 6 dB noise reduction over a comparable single belt system. FIG. 5 is a graph of an overall dB comparison between single belt systems, dual belt systems using the inventive system, and a single belt system using a belt with helix teeth. Bars A, C, D, and F represent the noise from single belt systems. Bar B is a dual belt system using single belt sprockets. Bar E represents the sound pressure levels for an inventive system, also using two belts. Bar G is for a single belt helix pitch system. Bar H is the electric motor only. The inventive system represented by bar (E) is quieter that all of the single belt systems.

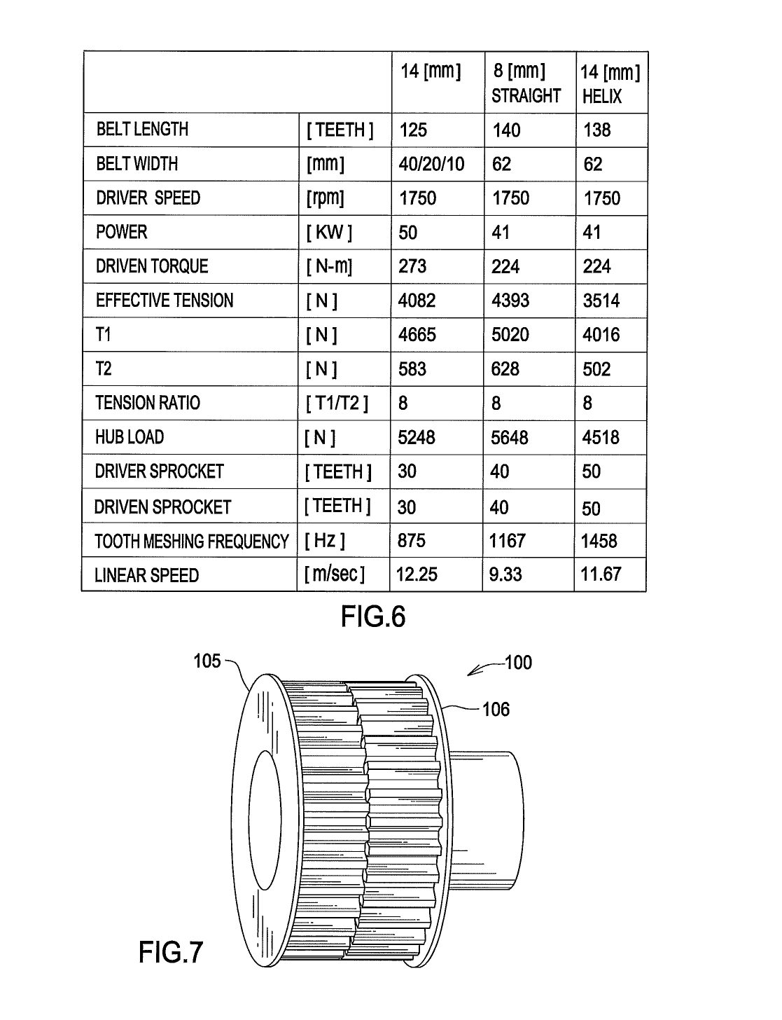

Parameters for the tested systems are shown in FIG. 6.

FIG. 7 is a perspective view of an inventive sprocket. Flanges 105 and 106 retain each belt 400, 300 respectively on sprocket 100. Flanges 105 and 106 are situated on the outboard portions of sprocket 100.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims. All references cited herein are incorporated in their entirety by reference.

What is claimed is:

1. A sprocket system comprising:
a first sprocket (100) comprising a plurality of transverse first teeth (101) extending parallel to an axis of rotation (A-A) and having a first pitch (P1);
the first sprocket further comprising a plurality of transverse second teeth (102) having a second pitch (P2) and disposed immediately adjacent the first teeth, the second teeth parallel to the first teeth;
a tooth of said first teeth aligned with a radius (A) of said first sprocket;
a tooth of said second teeth offset a distance (x) from said radius (A), wherein (x) is greater than zero;
a second sprocket (200); and
a toothed belt (300) entrained between the first sprocket and the second sprocket.

2. The sprocket system as in claim 1, wherein (P1) and (P2) are equal.

3. The sprocket system as in claim 2, wherein distance (x) is equal to (P1)/2.

4. The sprocket system as in claim 1 further comprising a second belt entrained between the first sprocket and the second sprocket.

5. The sprocket system as in claim 1, wherein the first teeth have a diameter (D) that is not equal to a diameter of the second teeth.

6. The sprocket system as in claim 1, wherein the second sprocket comprises:
a plurality of transverse first teeth (201) extending parallel to an axis of rotation (A-A) and having a pitch;
the second sprocket further comprising a plurality of transverse second teeth (202) having a pitch and disposed immediately adjacent the first teeth (201), the second teeth parallel to the first teeth;
a tooth of said first teeth (201) aligned with a radius (A) of said second sprocket; and
a tooth of said second teeth (202) disposed a distance (x) from said radius (A), wherein (x) is greater than zero.

7. A drive system comprising:
a first sprocket (100) comprising a plurality of transverse first teeth (101) extending parallel to an axis of rotation (A-A) and having a first pitch (P1);
the first sprocket further comprising a plurality of transverse second teeth (102) having a second pitch (P2) and disposed immediately adjacent the first teeth, the second teeth parallel to the first teeth;
a tooth of said first teeth aligned with a radius (R) of said first sprocket;
a tooth of said second teeth disposed a distance (x) from said radius (A), wherein (x) is greater than zero;
a second sprocket (200); and
a first toothed belt (300) and a second toothed belt (400), each belt entrained between the first sprocket and the second sprocket.

8. The drive system as in claim 7, wherein (P1) and (P2) are equal.

9. The drive system as in claim 8, wherein distance (x) is equal to (P1)/2.

10. A drive system comprising:
a first sprocket (100) comprising a plurality of transverse first teeth (101) extending parallel to an axis of rotation (A-A) and having a first pitch (P1);
the first sprocket further comprising a plurality of transverse second teeth (102) having a second pitch (P2) and disposed immediately adjacent the first teeth, the second teeth parallel to the first teeth;
a tooth of said first teeth aligned with a radius (A) of said first sprocket;
a tooth of said second teeth disposed a distance (x) from said radius (A), wherein (x) is greater than zero;
a second sprocket (200) comprising a plurality of transverse first teeth (201) extending parallel to an axis of rotation (A-A) and having a pitch;
the second sprocket further comprising a plurality of transverse second teeth (202) having a pitch and disposed immediately adjacent the first teeth (201), the second teeth parallel to the first teeth;
a tooth of said first teeth (201) aligned with a radius (A) of said second sprocket, a tooth of said second teeth (202) disposed a distance (x) from said radius (A), wherein (x) is greater than zero; and
a first toothed belt (300) and a second toothed belt (400) entrained between the first sprocket and the second sprocket.

11. The drive system as in claim 10, wherein (P1) and (P2) are equal.

12. The drive system as in claim 11, wherein distance (x) is equal to (P1)/2.
